(19) United States
(12) Patent Application Publication
(10) Pub. No.: US 2026/0161590 A1
(43) Pub. Date: Jun. 11, 2026

(54) MEMORY DEVICE AND OPERATION METHOD INCLUDING THE SAME

(71) Applicant: KOREA UNIVERSITY RESEARCH AND BUSINESS FOUNDATION, Seoul (KR)

(72) Inventors: Seon Wook Kim, Namyangju-si (KR); Seok Young Kim, Seongnam-si (KR)

(21) Appl. No.: 19/325,164

(22) Filed: Sep. 10, 2025

(30) Foreign Application Priority Data
Dec. 5, 2024 (KR) 10-2024-0179244
Mar. 4, 2025 (KR) 10-2025-0027541

(51) Int. Cl. G06F 13/40; G06F 7/575; G06F 13/16

(52) U.S. Cl. CPC G06F 13/4068; G06F 7/575; G06F 13/1642; G06F 13/1689

(57) ABSTRACT

A memory device includes an input/output circuit to receive an input signal of data, command, and address from a memory controller. A PIM IU generates a calculation command from the input signal. A PIM calculation circuit, receiving the input signal and the command, performs in-memory calculation based on first and second operand data. The PIM calculation circuit includes multiple memory banks storing at least one operand, a PIM calculator receiving both operands from the banks and executing the calculation in response to the command, and a shared bus circuit electrically connecting the banks and the calculator.

### CROSS-REFERENCE TO RELATED APPLICATIONS

This application claims priorities under 35 U.S.C. § 119 to Korean Patent Application No. 10-2024-0179244 filed on Dec. 5, 2024 and Korean Patent Application No. 10-2025-0027541 filed on Mar. 4, 2025, in the Korean Intellectual Property Office, the disclosures of which are incorporated by reference herein in their entireties.

### BACKGROUND

Embodiments of the present disclosure described herein relate to a memory device performing in-memory calculations and a method of operating the same.

The data used in applications that apply the latest technologies such as deep learning and neural networks are very large in volume and have low locality. The traditional computing structure, the von Neumann computing architecture, consists of a CPU (Central Processing Unit) that includes a calculation unit and a main memory that stores data required for calculations, and is optimized for high-locality data calculations. Therefore, when the applications are executed in the existing computing architecture, unnecessary data movement and memory bottlenecks occur. In detail, data with low locality are stored in a cache used to quickly access reused data, which prevents efficient use of the cache, and most of the massive data required for calculations should be read from the main memory, not the cache.

To solve this problem, in-memory calculations are developed that perform calculations in the main memory by installing a simple calculator inside the memory device and transmit only the calculation results to the CPU. Recently, research on in-memory calculation devices that may be implemented simply through a low-area design and enable high-speed calculations is actively underway.

### SUMMARY

Embodiments of the present disclosure provide a memory device including an in-memory calculator that may be implemented with a small area and low power and capable of high-speed operation, and an operating method thereof.

According to an example embodiment, a memory device includes an input/output circuit configured to receive an input signal including data, a command, and an address signal output from a memory controller, a PIM IU (processing in memory interface unit) configured to receive the input signal and to generate and output a calculation command based on the input signal, and a PIM calculation circuit configured to receive the input signal and the calculation command and to perform an in-memory calculation based on first operand data and second operand data, and wherein the PIM calculation circuit includes a plurality of memory banks configured to store at least one of the first operand data or the second operand data, a PIM calculator configured to receive the first operand data and the second operand data from the plurality of memory banks and to perform the in-memory calculation based on the first operand data and the second operand data, in response to the calculation command, and a shared bus circuit configured to electrically connect each of the plurality of memory banks and the PIM calculator.

According to an example embodiment, a method of operating a memory device includes receiving an input signal including data, a command, and an address signal output from a memory controller, generating and outputting a calculation command based on the input signal, storing at least one of first operand data or second operand data in a plurality of memory banks based on the input signal, receiving, by a single PIM calculator shared by the plurality of memory banks, the first operand data and the second operand data from the plurality of memory banks, and performing, by the PIM calculator, an in-memory calculation based on the first operand data and the second operand data, in response to the calculation command.

According to an example embodiment, a memory system includes a memory controller configured to provide an input signal including data, a command, and an address signal, and a memory device configured to receive the input signal to perform an in-memory calculation, to generate a calculation result, and to provide the calculation result to the memory controller, and wherein the memory device includes an input/output circuit configured to receive an input signal including data, a command, and an address signal output from a memory controller, a PIM IU (processing in memory interface unit) configured to receive the input signal and to generate and output a calculation command based on the input signal, and a PIM calculation circuit configured to receive the input signal and the calculation command and to perform an in-memory calculation based on first operand data and second operand data, and wherein the PIM calculation circuit includes a plurality of memory banks configured to store at least one of the first operand data or the second operand data, a PIM calculator configured to receive the first operand data and the second operand data from the plurality of memory banks and to perform the in-memory calculation based on the first operand data and the second operand data, in response to the calculation command, and a shared bus circuit configured to electrically connect each of the plurality of memory banks and the PIM calculator.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a memory system, according to an embodiment of the present disclosure.

FIG. 2 is a diagram illustrating a memory device, according to an embodiment of the present disclosure.

FIG. 3 is a diagram illustrating an input/output circuit.

FIG. 4 is a diagram illustrating a PIM IU.

FIG. 5 is a diagram illustrating a PIM calculation circuit.

FIG. 6 is a diagram illustrating a data flow of a related technology that performs an in-memory calculation in synchronization with a tCCD.

FIG. 7 is a diagram illustrating a data flow of a memory device, according to an embodiment of the present disclosure.

FIG. 8 is a diagram illustrating a shared bus circuit and a PIM calculator, according to an embodiment of the present disclosure.

FIG. 9 is a diagram illustrating how a PIM calculator performs calculation processes.

FIG. 10 is a diagram illustrating detailed calculation processes of a PIM calculation circuit that performs a MAC calculation.

FIG. 11 is a diagram illustrating a data flow in a PIM calculation process of a related technology that performs a MAC calculation.

FIG. 12 is a diagram illustrating a data flow in a calculation process of a PIM calculator, according to an embodiment of the present disclosure.

FIG. 13 is a flowchart illustrating a calculation process of a PIM calculator that performs a MAC calculation, according to an embodiment of the present disclosure.

### DETAILED DESCRIPTION

Hereinafter, embodiments of the present disclosure may be described in detail and clearly to such an extent that an ordinary one in the art easily implements the present disclosure.

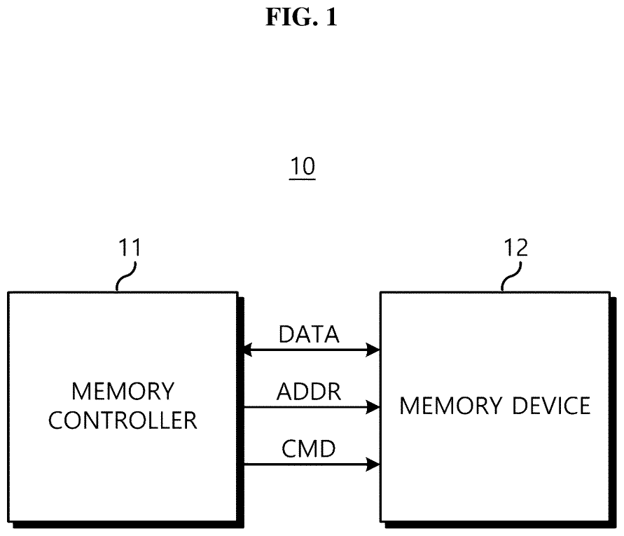

FIG. 1 is a diagram illustrating a memory system 10, according to an embodiment of the present disclosure.

Referring to FIG. 1, the memory system 10 according to an embodiment of the present disclosure may include a memory controller 11 and a memory device 12.

The memory controller 11 may be electrically connected to the memory device 12. The memory controller 11 may control the memory device 12 by transmitting and receiving data DATA to and from the memory device 12 or transmitting an address ADDR or a command CMD signal to the memory device 12. For example, the memory controller 11 may control the type and operand of calculations performed by the memory device 12.

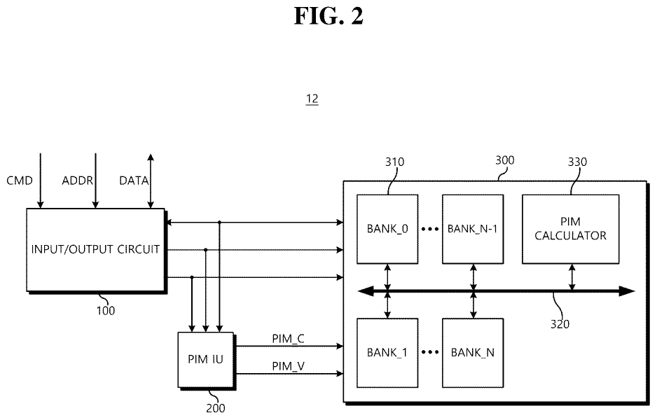

The memory device 12 may perform an in-memory calculation based on the data DATA, the address ADDR, and the command CMD signal from the memory controller 11. A description of the memory device 12 will be described later in FIG. 2 below.

The memory device 12 according to the present disclosure may include a DRAM (dynamic random access memory). In this case, the memory controller 11 may be implemented as a DRAM controller.

FIG. 2 is a diagram illustrating the memory device 12, according to an embodiment of the present disclosure.

Referring to FIG. 2, the memory device 12 may include an input/output circuit 100, a PIM IU (processing in memory interface unit) 200, and a PIM calculation circuit 300.

The input/output circuit 100 may receive an input signal including the data DATA, the address ADDR, and the command CMD signal from the memory controller 11. The input signal may include a standard memory request signal and a signal transferred to the PIM IU 200.

The PIM IU 200 may receive the input signal and may generate and output a signal for an in-memory calculation request based on the input signal. In this case, the signal for the in-memory calculation request may include a PIM command signal PIM_C and a PIM valid signal PIM_V. The PIM command signal PIM_C and the PIM valid signal PIM_V may be provided to the PIM calculation circuit 300.

The PIM calculation circuit 300 may include a plurality of memory banks, a shared bus circuit 320, and a PIM calculator 330. A memory bank 310 will be described as an example for the plurality of memory banks.

The memory bank 310 may include a plurality of memory cells. The plurality of memory cells may be arranged in a matrix form to form a memory cell array. The memory bank may store specific data or may output stored data under the control of the memory controller 11. Data stored or output in the memory bank 310 may be first operand data or second operand data.

The shared bus circuit 320 may electrically connect the plurality of memory banks and/or PIM calculator 330 to each other. Therefore, the plurality of memory banks and/or the PIM calculator 330 may transmit and receive data to each other through the shared bus circuit 320.

The PIM calculator 330 may receive the first operand data and the second operand data from the plurality of memory banks and may perform the in-memory calculation. In this case, the PIM calculator 330 may perform a calculation based on a signal for an in-memory calculation request output by the PIM IU 200.

As described above, the plurality of memory banks of the memory device 12 share one PIM calculator 330. Therefore, the memory device 12 may be implemented with a small area and low power. In addition, data sharing between the plurality of memory banks may be facilitated, and storage of duplicate data may be avoided.

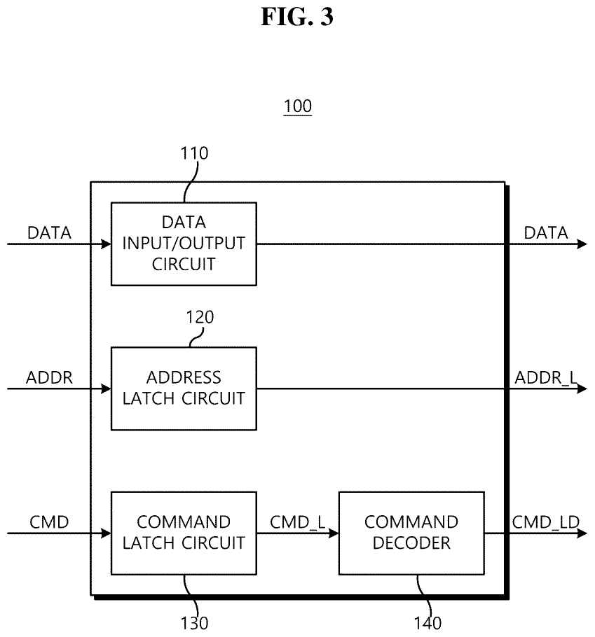

FIG. 3 is a diagram illustrating the input/output circuit 100, according to an embodiment of the present disclosure.

Referring to FIG. 3, the input/output circuit 100 may include a data input/output circuit 110, an address latch circuit 120, a command latch circuit 130, and a command decoder 140.

The data input/output circuit 110 may output the data DATA input from the memory controller 11 to the PIM IU 200 and/or the PIM calculation circuit 300. In addition, the data input/output circuit 110 may output the data DATA input from the PIM calculation circuit 300 to the memory controller 11.

The address latch circuit 120 may generate an address latch signal ADDR_L based on the address signal ADDR. The address latch signal ADDR_L may be provided to the PIM IU 200 and/or the PIM calculation circuit 300.

The command latch circuit 130 may generate a command latch signal CMD_L based on the command CMD signal.

The command decoder 140 may be electrically connected to the command latch circuit 130. The command decoder 140 may decode the command latch signal CMD_L and may output a decoding result CMD_LD to the PIM IU 200 and/or the PIM calculation circuit 300.

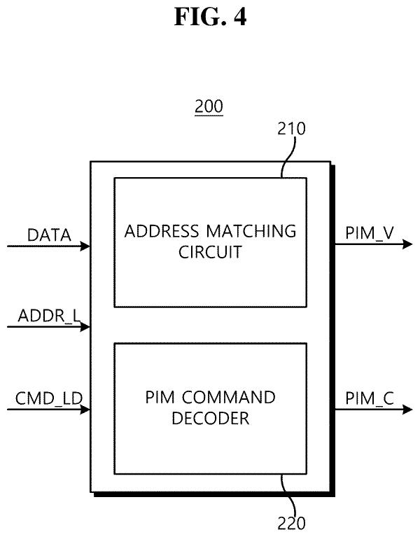

FIG. 4 is a diagram illustrating the PIM IU 200.

Referring to FIG. 4, the PIM IU 200 may include an address matching circuit 210 and a PIM command decoder 220.

The address matching circuit 210 may receive the address latch signal ADDR_L from the input/output circuit 100. The address matching circuit 210 may match address information with broadcast address information that is stored in advance, and may generate and output the PIM valid signal PIM_V. That is, the address matching circuit 210 may determine whether the address information is an address to be broadcast.

The PIM command decoder 220 may generate and output the PIM command signal PIM_C that indicates the type of calculation to be performed by the PIM calculation circuit 300. The PIM command decoder 220 may store an opcode for generating the PIM command signal PIM_C in advance. For example, the PIM command decoder 220 may generate the PIM command signal PIM_C based on the opcode that is stored in advance and the decoding result CMD_LD.

The PIM valid signal PIM_V and the PIM command signal PIM_C may be referred to as calculation commands.

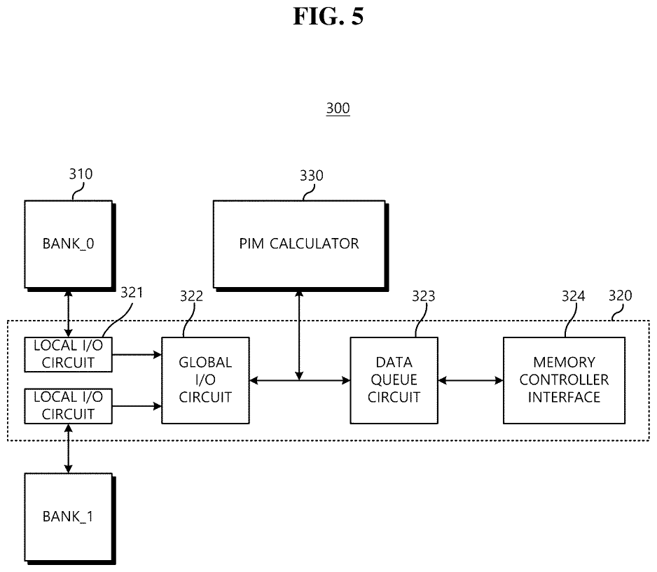

FIG. 5 is a diagram illustrating the PIM calculation circuit 300. A description similar to or overlapping with the description referring to FIG. 2 is omitted below to avoid redundancy. Although FIG. 5 illustrates including two memory banks as an example, the present disclosure is not limited thereto and may include more than two or more memory banks.

The shared bus circuit 320 may include a local I/O circuit 321, a global I/O circuit 322, a data queue circuit 323, and a memory controller interface 324.

The local I/O circuit 321 may be used when reading data from each of the plurality of memory banks or writing data into each of the plurality of memory banks. In detail, the local I/O circuit 321 may be arranged adjacent to each of the plurality of memory banks and may operate at high speed. For example, the local I/O circuit 321 arranged adjacent to the bank_0 310 may read data stored in the memory cell of the bank_0 310 at high speed during a read operation.

Although the local I/O circuit 321 is described as an example, local I/O circuits may be arranged corresponding to each of the plurality of memory banks. Therefore, data paths for each of the plurality of memory banks are secured, and parallel data access may be possible.

The global I/O circuit 322 may be used when reading data from the perspective of the entire plurality of memory banks or writing data into each of the plurality of memory banks. In detail, the global I/O circuit 322 is electrically connected to a plurality of local I/O circuits, and may process output data of each local I/O circuit so as to output to the data queue circuit 323.

For example, the global I/O circuit 322 may amplify output data of the local I/O circuits so as to output to the data queue circuit 323.

The data queue circuit 323 may temporarily store data processed and output by the global I/O circuit 322 so as to output to the memory controller interface 324. For example, the data queue circuit 323 may output data based on a first in first out (FIFO) method. The data queue circuit 323 may be implemented by connecting a plurality of pins in parallel.

The data queue circuit 323 according to an embodiment of the present disclosure may input or output data based on a burst clock signal. In addition, the data queue circuit 323 according to the embodiment of the present disclosure may determine the number of data to be input or output based on a burst length.

The memory controller interface 324 may output the data output by the data queue circuit 323 to the memory controller 11.

The PIM calculator 330 may be electrically connected between the global I/O circuit 322 and the data queue circuit 323. Therefore, the calculation of the PIM calculator 330 may be performed in synchronization with the cycle of the burst clock signal during the burst operation of the PIM calculation circuit 300.

In the case of the related technology, the PIM calculator 330 is electrically connected between the data queue circuit 323 and the memory controller interface 324. That is, the PIM calculation is performed while each memory bank occupies the global I/O circuit 322, the data queue circuit 323, and the memory controller interface 324 for a tCCD time. As a result, the PIM calculation is performed in synchronization with the above-mentioned occupancy time of each memory bank. Hereinafter, the above-mentioned occupancy time of the related technology is referred to as tCCD.

In contrast, the PIM calculator 330 according to the embodiment of the present disclosure performs the PIM calculation in synchronization with the burst clock signal cycle of the memory device 12, so it may have a number of input lines with lower complexity compared to the related technology. Therefore, high-speed operation and low-area implementation of the PIM calculator 330 may be possible. Hereinafter, the burst clock signal cycle of the memory device 12 is referred to as a tBL.

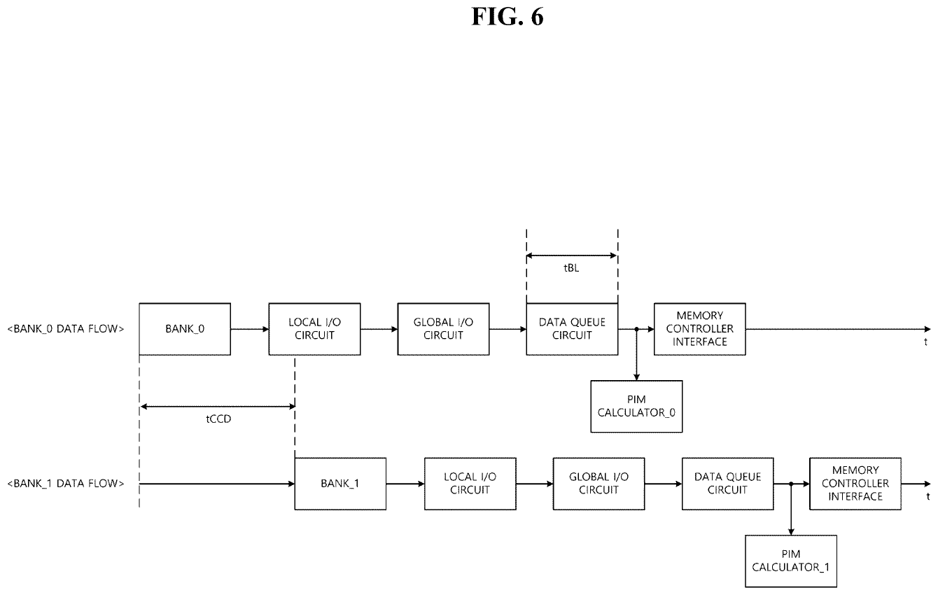

FIG. 6 is a diagram illustrating a data flow of a related technology that performs an in-memory calculation in synchronization with the tCCD.

Referring to FIG. 6, each bank (bank_0, bank_1) of the related technology occupies the local I/O circuit, the global I/O circuit, the data queue circuit, and the memory controller interface during the tCCD. Due to this, in the case of the related technology, the speed (based on the tCCD) at which data is supplied to the PIM calculator and the speed at which the actual PIM calculation is performed are inconsistent.

In detail, in the related technology, since the timing (during the tBL) at which the PIM calculator receives data and the timing (synchronized to the tCCD) at which the PIM calculation is performed are different, the PIM calculation is not performed even though data is supplied during the BL (burst length) cycle tBL. Therefore, a problem occurs in which memory bandwidth and PIM calculation resources are wasted. As a result, the performance of the entire memory system may be degraded.

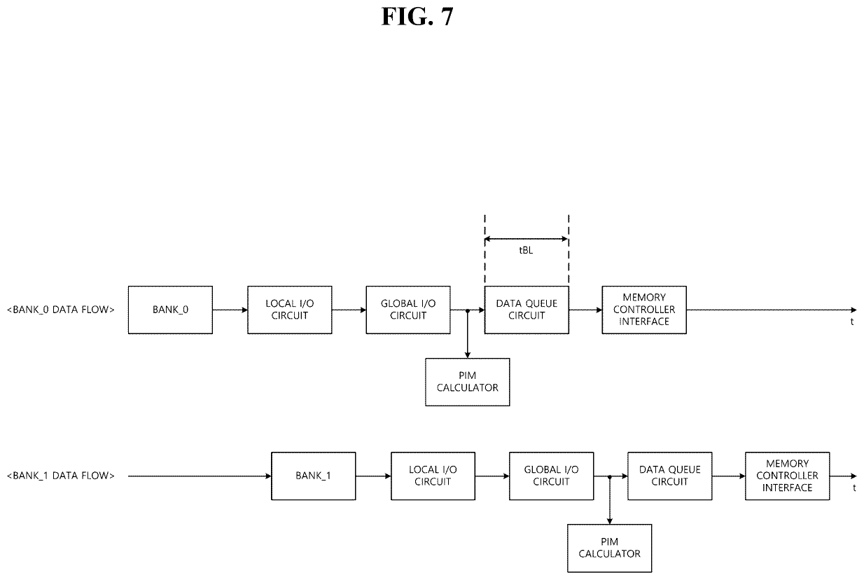

FIG. 7 is a diagram illustrating a data flow of the memory device 12, according to an embodiment of the present disclosure.

Referring to FIG. 7, the memory device 12 may perform a PIM calculation while data is read from the bank_0 during the tBL in the data queue. In other words, the PIM calculation may be performed in synchronization with the tBL, not the tCCD.

In detail, the memory device 12 may hook the data when the data is transferred from the global I/O circuit to the data queue and supply the data to the PIM calculator during the tBL. Therefore, the memory device 12 may secure continuity in the calculation of the PIM calculator by continuously processing the data during the tBL.

As described above, the memory device may easily utilize the calculation resources by synchronizing the PIM calculation with the tBL. Therefore, since the number of inputs to the PIM calculator may be reduced, the design of the PIM calculator may be simplified and made lightweight.

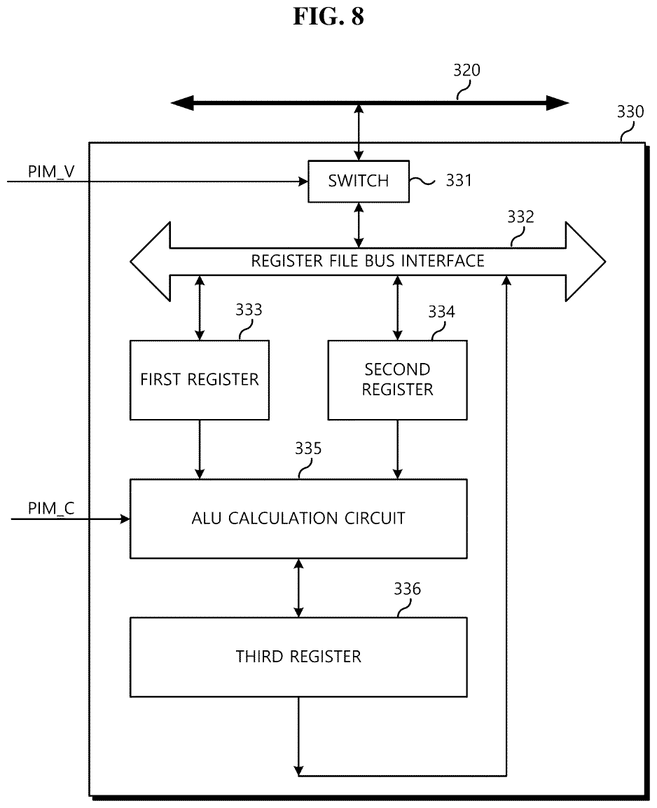

FIG. 8 is a diagram illustrating the shared bus circuit 320 and the PIM calculator 330, according to an embodiment of the present disclosure.

Referring to FIG. 8, the PIM calculator 330 may include a switch 331, a register file bus interface 332, a first register 333, a second register 334, an ALU calculation circuit 335, and a third register 336.

The switch 331 may control an electrical connection between the PIM calculator 330 and the shared bus circuit 320 based on the PIM valid signal PIM_V. For example, the switch 331 may connect the shared bus circuit 320 to the PIM calculator 330 when the PIM valid signal PIM_V indicates that the address information matches the broadcast address information that is stored in advance.

The first register 333 may store the first operand data. The first operand data may be stored in a plurality of memory banks. The first register 333 may store the first operand data that are sequentially broadcast when the switch 331 is turned on and the shared bus circuit 320 is connected to the PIM calculator 330.

The second register 334 may store the second operand data. The second operand data may be stored in a plurality of memory banks. The second register 334 may read and store the second operand data stored in the plurality of memory banks through the register file bus interface 332. As described above, the second operand data may be hooked and provided to the second register when the second operand data is transmitted from the global I/O circuit 322 to the data queue circuit 323.

The ALU calculation circuit 335 may receive the first operand data from the first register 333 and the second operand data from the second register 334, may perform a calculation, and may generate a calculation result. The ALU calculation circuit 335 may determine the type of calculation to be performed based on the PIM command signal PIM_C.

For example, the ALU calculation circuit 335 may perform a MAC (multiply-accumulate) calculation. However, this is an example, and the ALU calculation circuit 335 may perform other calculations and may be provided with multiple numbers.

The third register 336 may receive the calculation result from the ALU calculation circuit 335 so as to store.

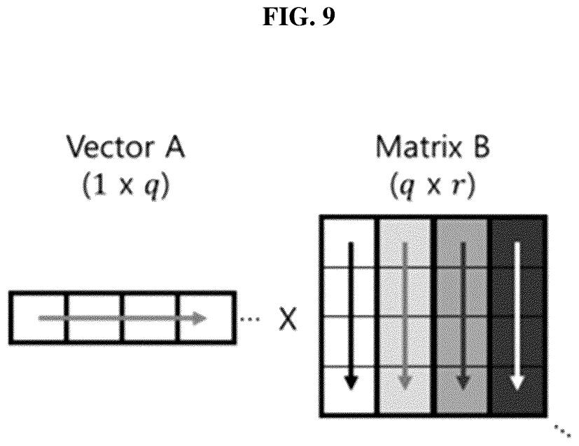

FIG. 9 is a diagram illustrating how the PIM calculator 330 performs calculation processes. Descriptions similar to or overlapping with those referring to FIGS. 1 to 8 will be omitted below to avoid redundancy.

Referring to FIG. 9, the PIM calculator 330 may perform a vector-matrix multiplication calculation. For example, a vector A has a size of 1×4 and a matrix B has a size of 4×4. In this case, the ALU calculation circuit 335 may include four ALUs. FIG. 9 is for describing the calculation of the PIM calculator 330 as an example, and the PIM calculator 330 may perform a calculation other than the vector-matrix multiplication, and may perform a calculation based on a vector and/or matrix of a different size.

Each element of the vector A may be referred to as first operand data, and each element of the matrix B may be referred to as second operand data.

As described above, the first operand data and the second operand data may be stored in a plurality of memory banks. First, the first operand data may be read from each memory bank and may be stored in the first register 333. In this case, the PIM calculator 330 may not start the calculation.

Thereafter, the second operand data may be read from each memory bank and may be stored in the second register 334. In addition, the second operand data stored in the second register 334 may be transferred to the ALU calculation circuit 335, and at the same time, the first operand data stored in the first register 333 may also be transferred to the ALU calculation circuit 335.

The ALU calculation circuit 335 may include four ALUs as described above. In this case, one ALU may independently calculate the partial sum for the second operand data corresponding to one column of the matrix B.

Thereafter, the final calculation result may be stored in the third register 336.

As described above, unlike the related technology in which the PIM calculator is independently arranged for each memory bank, the memory device 12 may be implemented using only one PIM calculator 330.

In this case, as described above, the PIM calculator 330 is electrically connected between the global I/O circuit 322 and the data queue circuit 323, and all the register files of each memory bank may be implemented as a single register file.

In addition, when the PIM command signal PIM_C is provided, data (second operand data) corresponding to the ID of the memory bank to be used in the register file is hooked and provided to the ALU calculation circuit 335.

As a result, the memory device 12 may be implemented in a lightweight manner by using only one PIM calculator 330. In addition, since all the memory banks share one register file, data sharing between the memory banks may be facilitated and storage of duplicated data may be avoided.

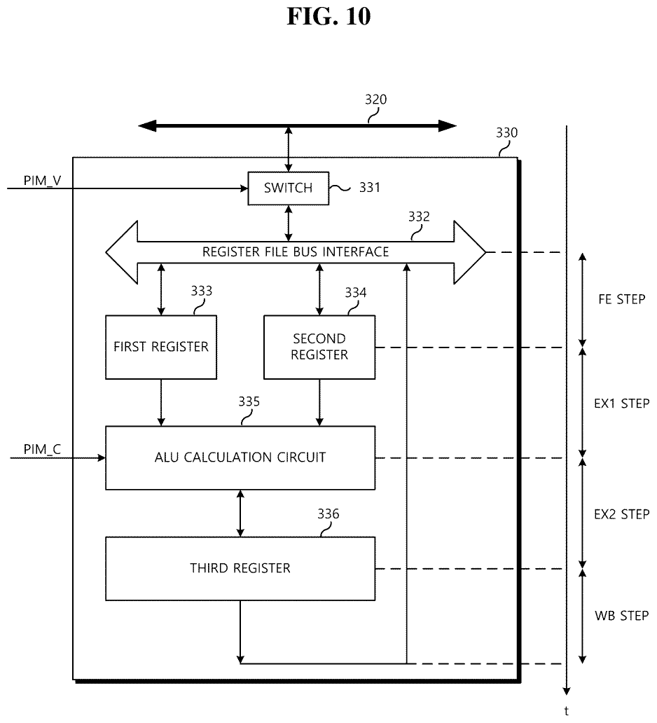

FIG. 10 is a diagram illustrating detailed calculation processes of the PIM calculator 330 that performs a MAC calculation. A description similar to or overlapping with the description referring to FIGS. 8 and 9 will be omitted below to avoid redundancy.

Referring to FIG. 10, an FE step may be a step in which the PIM calculator 330 receives the first operand data and the second operand data from the plurality of memory banks and stores them in the first register 333 and the second register 334.

An EX1 step may be a step in which the PIM calculator 330 performs a multiplication calculation, which is the first step of the MAC calculation, on the first operand data and the second operand data.

An EX2 step may be a step in which the PIM calculator 330 performs an addition calculation, which is the second step of the MAC calculation.

A WB step may be a step in which the MAC calculation result is stored in the third register 336.

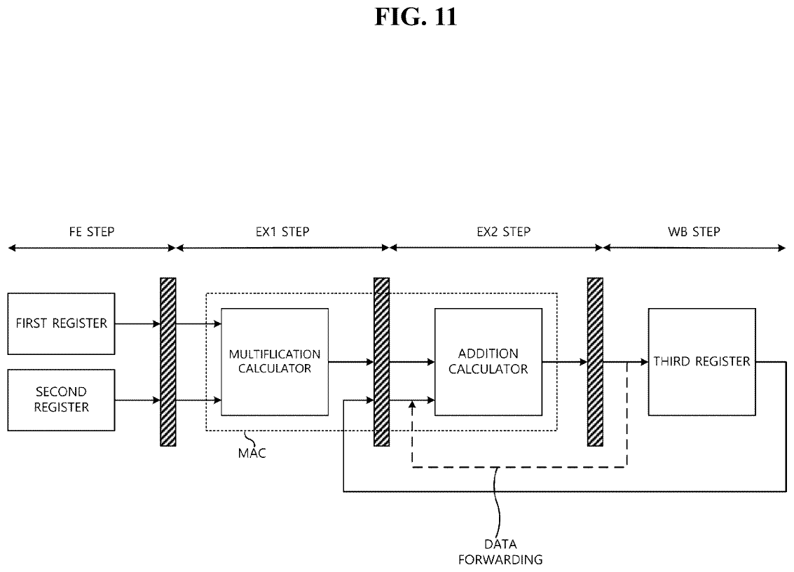

FIG. 11 is a diagram illustrating a data flow in a PIM calculation process of a related technology that performs a MAC calculation. The FE step, EX1 step, EX2 step, and WB step referring to FIG. 11 may be steps corresponding to each step described in FIG. 10.

In the case of the related technology, as mentioned above, the PIM calculation is synchronized to the tCCD. Therefore, when two command signals are inputted consecutively to the same bank, the value of the third register storing the PIM calculation result should be used in the next calculation cycle. As a result, data forwarding occurs from the third register to an addition calculator.

In detail, the first calculation result is stored in the third register based on a first command signal. Thereafter, when the second calculation is performed based on the second command signal, the calculation result based on the first command signal should be used in the second calculation. Therefore, the first calculation result stored in the third register should be transferred to the addition calculator of the second calculation. In other words, since the second command signal is executed consecutively in the tCCD, the first calculation result value should be used in the second calculation cycle based on the second command signal.

In the case of related technologies, since logic for performing data forwarding as described above is required, problems of increased hardware design complexity and timing constraints may occur.

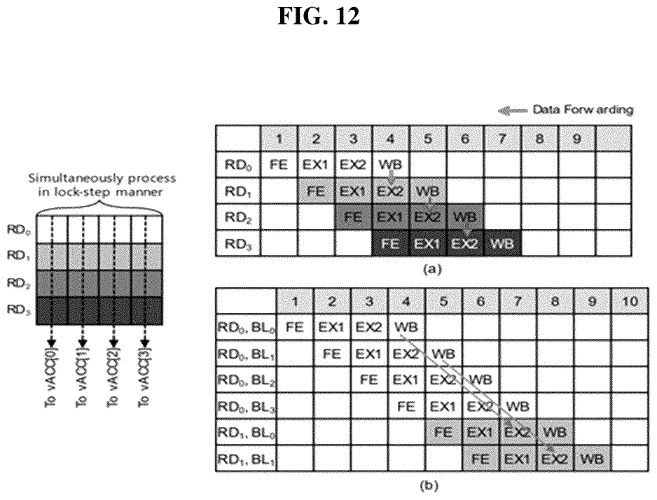

FIG. 12 is a diagram illustrating a data flow in the calculation process of the PIM calculator 330, according to an embodiment of the present disclosure.

Referring to FIG. 12, Table (a) is a table that organizes the data flow of the related technology. Each row of Table (a) indicates which cycle it is, and each column indicates each row of the calculation result (in the form of a 4×4 matrix).

Referring to Table (a), operands in RD0 are used in the WB step of a 4th cycle and at the same time in the EX2 step of RD1. In this case, since the value of the WB step of RD0 should be used from a 5th cycle of RD1, data forwarding occurs from the WB step of RD0 to the EX2 step of RD1.

Referring to FIG. 12, Table (b) is a table that organizes the data flow of the PIM calculator 330 according to one embodiment of the present disclosure. In this case, the burst length BL is assumed to be “4”, and each data value of the burst may be referred to as BL0, BL1, BL2, and BL3.

Referring to Table (b), the PIM calculator 330 may use the operands of RD0 and BL0 in the WB step of the 4th cycle according to the application of the burst concept. In addition, the operands of RD1 and BL0 are in a state where the operand values of RD0 and BL0 may already be used in the EX2 step of the 7th cycle. Therefore, the PIM calculator 330 does not require data forwarding.

As described above, the operand elements supplied during the tBL of the PIM calculator 330 are independent of each other. That is, by synchronizing the calculation process to the tBL, the data forwarding logic circuit that is essential in the related technology may be removed. As a result, the circuit configuration may be simplified and the operation may be accelerated.

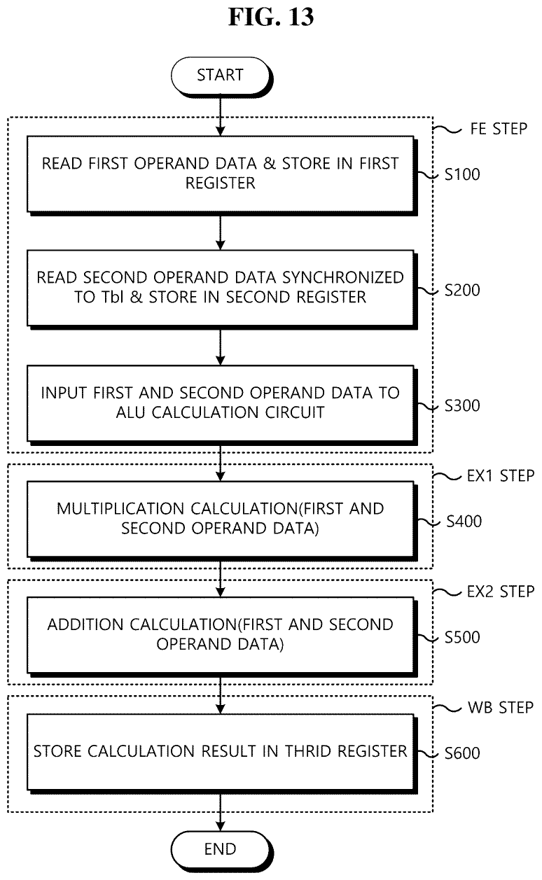

FIG. 13 is a flowchart illustrating a calculation process of the PIM calculator 330 that performs a MAC calculation, according to an embodiment of the present disclosure.

Referring to FIG. 13, in operation S100, the PIM calculator 330 may read the first operand data from the plurality of memory banks so as to store in the first register 333.

In operation S200, the PIM calculator 330 may read the second operand data from the plurality of memory banks in synchronization with the tBL so as to store in the second register 334.

In operation S300, the first operand data and the second operand data may be input into the ALU calculation circuit 335. Operations S100 to S300 may correspond to the FE step.

In operation S400, a multiplication calculation of the first operand data and the second operand data may be performed. Operation S400 may correspond to the EX1 step.

In operation S500, an addition calculation of the first operand data and the second operand data may be performed. Operation S500 may correspond to the EX2 step.

In operation S600, a calculation result may be stored in the third register 336. Operation S600 may correspond to the WB step.

The memory device 12 according to an embodiment of the present disclosure may synchronize the PIM calculation process with the burst clock signal cycle tBL. The memory device 12 according to an embodiment of the present disclosure may centralize the PIM calculator and register designed for each memory bank into one to perform the PIM calculation process. The memory device 12 according to an embodiment of the present disclosure may operate without a data forwarding logic circuit in the PIM calculator.

As a result, the memory device 12 according to an embodiment of the present disclosure may implement the PIM calculator with a small area and low power, and may enable high-speed calculation.

According to an embodiment of the present disclosure, the memory device may be implemented with a small area and low power, and may perform in-memory calculations at high speed.

Meanwhile, the above descriptions are specific embodiments for carrying out the present disclosure. Embodiments in which a design is simply changed or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A memory device comprising:
an input/output circuit configured to receive an input signal including data, a command, and an address signal output from a memory controller;
a PIM IU (processing in memory interface unit) configured to receive the input signal and to generate and output a calculation command based on the input signal; and
a PIM calculation circuit configured to receive the input signal and the calculation command and to perform an in-memory calculation based on first operand data and second operand data, and
wherein the PIM calculation circuit includes:
a plurality of memory banks configured to store at least one of the first operand data or the second operand data;
a PIM calculator configured to receive the first operand data and the second operand data from the plurality of memory banks and to perform the in-memory calculation based on the first operand data and the second operand data, in response to the calculation command; and
a shared bus circuit configured to electrically connect each of the plurality of memory banks and the PIM calculator.

2. The memory device of claim 1, wherein the PIM calculation circuit includes the single PIM calculator, and the plurality of memory banks share the single PIM calculator.

3. The memory device of claim 1, wherein the PIM calculator is configured to receive the first operand data and the second operand data from the plurality of memory banks based on a burst clock signal.

4. The memory device of claim 3, wherein the shared bus circuit includes:
a global input/output circuit configured to receive and output the first operand data or the second operand data from each of the plurality of memory banks; and
a data queue circuit configured to receive the first operand data or the second operand data from the global input/output circuit based on the burst clock signal and to sequentially output the first operand data or the second operand data in a number corresponding to a burst length, and
wherein the PIM calculator is configured to be electrically connected between the global input/output circuit and the data queue circuit and is configured to receive the first operand data or the second operand data.

5. The memory device of claim 1, wherein the PIM calculator includes:
a first register configured to store the first operand data;
a second register configured to store the second operand data;
an ALU calculation circuit configured to perform the in-memory calculation based on the first operand data and the second operand data in response to the calculation command to generate a calculation result; and
a third register configured to store the calculation result.

6. A method of operating a memory device, the method comprising:
receiving an input signal including data, a command, and an address signal output from a memory controller;
generating and outputting a calculation command based on the input signal;
storing at least one of first operand data or second operand data in a plurality of memory banks based on the input signal;
receiving, by a single PIM calculator shared by the plurality of memory banks, the first operand data and the second operand data from the plurality of memory banks; and
performing, by the PIM calculator, an in-memory calculation based on the first operand data and the second operand data, in response to the calculation command.

7. The method of claim 6, wherein the receiving, by the PIM calculator, of the first operand data and the second operand data from the plurality of memory banks includes:
receiving, by the PIM calculator, the first operand data through a shared bus circuit;
storing the received first operand data in a first register;
receiving, by the PIM calculator, the second operand data through the shared bus circuit; and
storing the received second operand data in a second register.

8. The method of claim 7, wherein the shared bus circuit transfers the first operand data or the second operand data in a number corresponding to a burst length to the PIM calculator, based on a burst clock signal.

9. The method of claim 6, wherein the performing, by the PIM calculator, of the in-memory calculation based on the calculation command includes:
performing, by an ALU calculation circuit, the in-memory calculation based on the first operand data and the second operand data in response to the calculation command to generate a calculation result; and
storing the calculation result in a third register.

10. A memory system comprising:
a memory controller configured to provide an input signal including data, a command, and an address signal; and
a memory device configured to receive the input signal to perform an in-memory calculation, to generate a calculation result, and to provide the calculation result to the memory controller, and
wherein the memory device includes:
an input/output circuit configured to receive the input signal output from the memory controller;
a PIM IU configured to receive the input signal and to generate and output a calculation command based on the input signal; and
a PIM calculation circuit configured to receive the input signal and the calculation command and to perform an in-memory calculation based on first operand data and second operand data, and
wherein the PIM calculation circuit includes:
a plurality of memory banks configured to store at least one of the first operand data or the second operand data;
a PIM calculator configured to receive the first operand data and the second operand data from the plurality of memory banks and to perform the in-memory calculation based on the first operand data and the second operand data, in response to the calculation command; and
a shared bus circuit configured to electrically connect each of the plurality of memory banks and the PIM calculator.

11. The memory system of claim 10, wherein the shared bus circuit transfers the first operand data or the second operand data in a number corresponding to a burst length based on a burst clock signal to the PIM calculator.
